(19) United States
(12) Patent Application Publication
(10) Pub. No.: US 2025/0289305 A1
(43) Pub. Date: Sep. 18, 2025

(54) VEHICLE HUMAN MACHINE INTERFACE WITH SELECTABLE DISPLAY MODES PROVIDING VARYING LEVELS OF INFORMATION

(71) Applicant: LiveWire EV, LLC, Milwaukee, WI (US)

(72) Inventors: Vance Strader, Asheville, NC (US); Daniel Lehrbaum, Waukesha, WI (US)

(21) Appl. No.: 19/076,650

(22) Filed: Mar. 11, 2025

Related U.S. Application Data
(60) Provisional application No. 63/565,626, filed on Mar. 15, 2024.

(51) Int. Cl. B60K 35/22; B60K 35/10; B60K 35/50; B60K 35/65

(52) U.S. Cl. CPC B60K 35/22; B60K 35/10; B60K 35/50; B60K 35/652; B60K 35/654; B60K 2310/242; B60K 2310/248; B60K 2360/11; B60K 2360/166; B60K 2360/167; B60K 2360/169; B60K 2360/172; B60K 2360/178; B60Y 2200/12

(57) ABSTRACT

Systems and methods for displaying information regarding a vehicle on a display device of a vehicle. One system includes a display device, an input device, and an electronic controller including an electronic processor and memory. The electronic controller is configured, during operation of the vehicle, to display, on the display device, information regarding the vehicle in a first display mode of a plurality of available display modes, the first display mode including a first set of information, and, in response to receiving input via the input device while the information is displayed in the first display mode, switch to displaying information regarding the vehicle in a second display mode of the plurality of available display modes. The second display mode includes the first set of information and a second set of information, and the second set of information is configurable.

### RELATED APPLICATIONS

This application claims priority to U.S. Provisional Application No. 63/565,626, filed Mar. 15, 2024, the entire content of which is incorporated herein by reference.

### TECHNICAL FIELD

Embodiments described herein generally relate to human machine interfaces (HMIs) for vehicles, such as, for example, motorcycles and, in particular, selectable display modes for such HMIs.

### SUMMARY

A human machine interface (HMI) is, for example, a user interface (a display) or other user input and/or user output device that allows a user to interact with a machine, system, or device. HMIs can be used to, for example, visually display data and, optionally, receive user inputs and outputs. Vehicles are often equipped with one or more HMIs, such as, for example, one or more display devices, touchscreens, or the like that may present information as well as various menus and access controls for a vehicle. As HMIs display more and more information, users may experience information overload. Also, interacting with such HMIs, such as, for example, to navigate menus to locate and interact with various access controls, can cause visual (e.g., eyes off road), cognitive (e.g., mind off road), and/or manual (e.g., hands off a steering mechanism) distractions during vehicle driving conditions.

Accordingly, embodiments described herein provide methods and systems for operating an HMI of a vehicle, such as, for example, a motorcycle. In some embodiments, an input device coupled to a steering mechanism (e.g., a handlebar), a console, or other surface of a vehicle is configured to receive user input for controlling operation of the HMI, such as, for example, a display device of the vehicle. In some implementations, the input device is positioned proximate to a rider's thumb to facilitate use by the rider without removing the rider's hand from the handle. The input device reduces manual distractions when interacting with the HMI. In addition, the input device enables a rider to control how information is displayed on the HMI using, for example, no more than one action, which eliminates the iterative task of navigating menus, layers, or tabs and reduces cognitive and visual distractions. For example, the input device may allow a user to cycle to a plurality of available display modes for the HMI, wherein the display modes include varying levels of information. As one non-limiting example, the plurality of display modes may include a basic or minimal display mode (e.g., displaying a minimum amount of information), a user-defined or custom display mode (e.g., displaying the minimum amount of information plus other information as selected by a user), and an informative display mode (e.g., displaying the minimum amount of information plus additional information). A user can configure the custom mode using a software application (app) installed on a user device, such as the user's mobile phone, tablet computer, or other computing device and, while operating the vehicle, can use the input device to select one of the display modes (e.g., cycle through the available display modes).

Accordingly, embodiments described herein allow a user to easily switch between available display modes, such as, for example, using a single input or action (e.g., without having to navigate multiple layers of menus). The available display modes provide varying levels of information, wherein some information is constant between the different modes. Thus, a user can choose what information should be displayed to ensure that only the information that the user (rider) needs to see and wants to see is displayed (i.e., without displaying more). Furthermore, a user can change the display mode without requiring a change in operation of the vehicle, such as, for example, without requiring a change in a current ride mode, whether the vehicle is idle or being driven, or the like. In addition, at least one of the available display modes is customizable by the user (e.g., through a separate software application) to further customize the vehicle HMI.

For example, one embodiment provides a vehicle. The vehicle includes a display device, an input device, and an electronic controller including an electronic processor and memory. The electronic controller is configured, during operation of the vehicle, to display, on the display device, information regarding the vehicle in a first display mode of a plurality of available display modes, the first display mode including a first set of information, and, in response to receiving input via the input device while the information is displayed in the first display mode, switch to displaying information regarding the vehicle in a second display mode of the plurality of available display modes. The second display mode includes the first set of information and a second set of information, and the second set of information is configurable.

Another embodiment provides a system for controlling a human machine interface of a vehicle. The system includes an input device and an electronic controller including an electronic processor and memory. The electronic controller is configured, during operation of the vehicle, to set, from a plurality of available display modes, a display mode for information displayed via a display device, the plurality of available display modes including a first display mode including a first set of information, and a second display mode including the first set of information and a second set of information and being configurable, and switch, during operation of the vehicle, the display mode for information displayed via the display device among the plurality of available display modes in response to each input received via the input device.

Yet another embodiment provides a system of controls for a motorcycle. The system includes a first set of controls positioned on a first portion of a handlebar of the motorcycle. The first set of controls is limited to a horn input device, a turn signal input device, a communications input device, and a lighting input device. The system also includes a second set of controls positioned on a second portion of the handlebar. The second set of controls is limited to a start input device, a cruise control input device, a ride mode input device, and a display mode input device. The system further includes at least one controller receiving input from at least a subset of the first set of controls and the second set of controls.

A further embodiment provides a non-transitory computer-readable medium storing instructions that, when executed by an electronic processor, perform a set of functions. The set of functions includes providing a graphical user interface (GUI) for receiving configuration settings for a user-defined display mode of a vehicle. The GUI includes a plurality of GUI elements, each respective GUI element setting one of a first plurality of information types to one of a plurality of display settings. The set of functions further includes communicating the configuration settings to a controller included in the vehicle. The controller stores the configuration settings for use in response to selection of a user-defined display mode of the vehicle from a plurality of available display modes via at least one input device mounted on the vehicle. The plurality of available display modes including at least one fixed display mode including default display settings for a second plurality of information types.

Other independent aspects will become apparent by consideration of the detailed description and accompanying drawings.

### BRIEF DESCRIPTION OF THE DRAWINGS

FIG. 1A schematically illustrates a system for providing selectable display modes for a vehicle, in accordance with various embodiments disclosed herein.

FIG. 1B schematically illustrates a user device included in the system of FIG. 1A, in accordance with various embodiments described herein.

FIG. 2 schematically illustrates a human machine interface (HMI) control system included in the vehicle illustrated in FIG. 1A, in accordance with various embodiments disclosed herein.

FIG. 3 depicts an example user interface provided on the user device illustrated in FIG. 1A for configuring the vehicle of FIG. 1A, in accordance with various embodiments disclosed herein.

FIG. 4 illustrates configuration settings for the HMI control system of FIG. 2, in accordance with various embodiments disclosed herein.

FIGS. 5A-5B are example user interfaces representing different display modes presented via the HMI control system of FIG. 2, in accordance with various embodiments disclosed herein.

FIG. 6 is a flowchart illustrating a method performed via the HMI control system of FIG. 2 for providing selectable display modes, in accordance with various embodiments disclosed herein.

### DETAILED DESCRIPTION

Before any independent embodiments are explained in detail, it is to be understood that the methods and systems described herein are not limited in their application to the details of construction and the arrangement of components set forth in the following description or illustrated in the following drawings. The systems and methods described herein are capable of other independent embodiments and of being practiced or of being carried out in various ways. Some embodiments described herein may be integral to a vehicle while others may be peripheral to a vehicle controller or distributed between an integral component and a peripheral component.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

Relative terminology, such as, for example, “about”, “approximately”, “substantially”, etc., used in connection with a quantity or condition would be understood by those of ordinary skill to be inclusive of the stated value and has the meaning dictated by the context (for example, the term includes at least the degree of error associated with the measurement of, tolerances (e.g., manufacturing, assembly, use, etc.) associated with the particular value, etc.). Such terminology should also be considered as disclosing the range defined by the absolute values of the two endpoints. For example, the expression “from about 2 to about 4” also discloses the range “from 2 to 4”. In another example, the expression “approximately 0” may disclose the absence of a value to within at least a degree of reasonable tolerance. The relative terminology may refer to plus or minus a percentage (e.g., 1%, 5%, 10% or more) of an indicated value.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

Many of the modules and logical structures described are capable of being implemented in software executed by a microprocessor or a similar device or of being implemented in hardware using a variety of components including, for example, application specific integrated circuits (“ASICs”). Terms like “controller” and “module” may include or refer to both hardware and/or software. Capitalized terms conform to common practices and help correlate the description with the coding examples, equations, and/or drawings. However, no specific meaning is implied or should be inferred simply due to the use of capitalization. Thus, the claims should not be limited to the specific examples or terminology or to any specific hardware or software implementation or combination of software or hardware. Also, if an apparatus, method, or system is claimed, for example, as including a controller, module, logic, electronic processor, or other element configured in a certain manner, for example, to perform multiple functions, the claim or claim element should be interpreted as meaning one or more controllers, modules, logic elements, electronic processors other elements where any one of the one or more elements is configured as claimed, for example, to perform any one or more of the recited multiple functions.

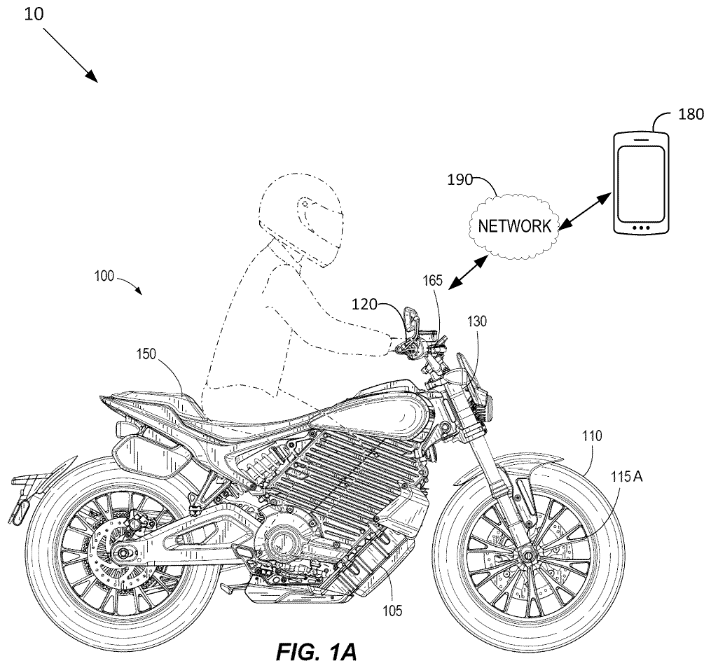

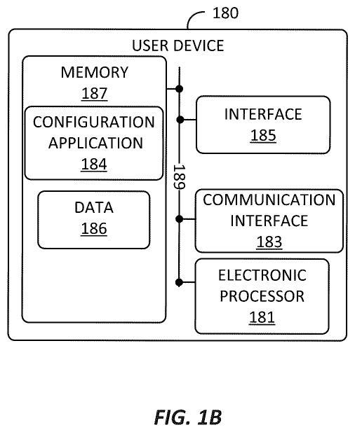

FIG. 1A schematically illustrates an example system 10 for providing selectable display modes for a vehicle, in accordance with various aspects. The system 10 includes a motorcycle 100, a user device 180 remote from the motorcycle 100, and a communication system 190. It should be understood that the system 10 illustrated in FIG. 1A represents one example implementation and does not imply any limitations with regard to the systems in which different embodiments may be implemented. Modifications to the depicted system may be made by those skilled in the art without departing from the scope of embodiments described herein.

The communication system 190 can be, for example, a local area network (“LAN”), a telecommunications network, a wide area network (“WAN”), such as the Internet, a personal area network (“PAN”), a short-range wireless communication system (e.g., Bluetooth®, near-field communication (“NFC”), ultra-wide band (“UWB”), Wi-Fi, etc.), or any combination thereof, and may include wired or wireless connections. In general, the communication system 190 can be any combination of connections and protocols that support communications between the motorcycle 100 and the user device 180, in accordance with embodiments of the present application. It should be understood that, in some embodiments, a dedicated wired connection may be used between the motorcycle 100 and the user device 180 to, among other things, receive configuration settings from the user device 180. For example, a Universal Serial Bus (USB) cable may be used to establish data communication between the motorcycle 100 and the user device 180.

As illustrated in FIG. 1A, the motorcycle 100 includes an electric motor 105, tires 110 on wheels 115 (a front wheel 115A and a rear wheel 115B), and a rechargeable power source, such as a battery (not shown). The motorcycle 100 includes a steering mechanism (e.g., handlebars 120), a frame 130, a seat 150, and a display device 165. It should be understood that the methods and systems described herein are not limited to use on electric motorcycles but may be used in other types of vehicles, including internal combustion engine vehicles and hybrid vehicles. Also, embodiments described herein are not limited to use with motorcycles and may be used, for example, on other types of vehicles, including passenger vehicles, commercial transport vehicles, boats, and other types of cageless vehicles, such as, for example, a motorized scooter, an all-terrain vehicle (“ATV”), powersports vehicles (for example, snowmobiles and personal watercrafts), a light utility vehicle, a moped, a go-kart, a bicycle, or any other type of vehicle that does not include an enclosed cabin.

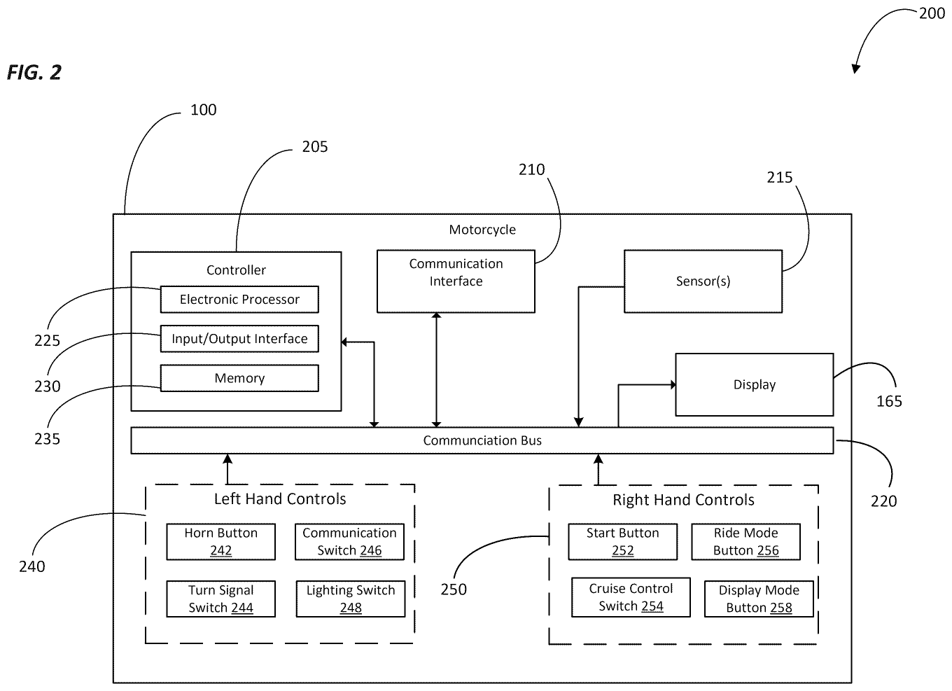

The handlebar 120 may be coupled to a front fork of the motorcycle 100 via a steering head for steering the front wheel 115A. Various controls (input mechanisms) and indicators for operating the motorcycle 100 may be located on the handlebars 120. In some instances, the handlebars 120 may include controls configured to control operation of the motorcycle 100, such as, for example, a set of one or more left hand controls 240 and a set of one or more right hand controls 250 as shown in FIG. 2. The controls may include a start button, a key/fob input, and/or another type of mechanism for starting the motorcycle 100 and such a control may be located on or near the handlebars 120. The controls may also include a throttle mechanism for generating a demand signal for torque to the rear wheel 115B. As described in further detail below, the controls may also include an input device (e.g., a display mode button or device 258) for controlling or configuring a human machine interface (“HMI”) of the motorcycle 100, which may be located on the handlebars 120 or in another location of the motorcycle 100, such as, for example, in a center console area.

The motorcycle 100 also includes a seat 150 for a rider (user). The motorcycle 100 further includes one or more HMIs, such as, for example, a display device 165. In some implementations, the display device 165 is a liquid crystal display (“LCD”), light emitting diode (“LED”) display, heads-up display, or the like. The display device 165 may be located on the handlebars 120 (e.g., in an area positioned between the right and left handlebar portions) or in another location of the motorcycle 100, such as, for example, in a center console area. In some implementations, the display device 165 is not a touch sensitive device (e.g., a touchscreen) to limit distractions to the rider. However, in other implementations, the display device 165 is a touch sensitive device but the touch-sensitive aspect of the device may be disabled in particular operating conditions (e.g., during operation or motion of the motorcycle 100, during motion of the motorcycle 100 exceeding a particular threshold, or the like).

The display device 165 provides user interfaces including information about the motorcycle 100, such as, for example, a travelling speed (a speedometer), a charge amount, a traveled distance (an odometer), or the like. The information may also include various indicators configured to alert a rider to conditions impacting the motorcycle 100 (e.g., low tire pressure, sensor errors, battery faults, temperature warnings, maintenance needs, or the like).

The information may be provided in one or more display modes as described in further detail below. As also described in more detail below, the input device (which may be mounted on the handlebars 120) may be configured to receive an input from the rider and modify the display mode of a user interface provided via the display device 165.

FIG. 2 illustrates an HMI control system 200 of the motorcycle 100. As illustrated in FIG. 2, the HMI control system 200 includes the display device 165, a controller 205, a communication interface 210, one or more sensor(s) 215, a communication bus 220, and a display mode device 258, which is described herein as a button as one non-limiting example. The display mode button 258 may be included in the set of left hand controls 240 or the set of right hand controls 250. For example, as illustrated in FIG. 2, in some implementations, the display mode button 258 is included in the set of right hand controls 250, although other configurations are possible. In some embodiments, the display mode button 258 is a dedicated input device for the HMI control system 200, meaning that the button 258 does not serve any other function or control any other feature or function of the motorcycle 100 other than the function described herein with respect to the HMI control system 200.

The display device 165, the controller 205, the communication interface 210, sensor(s) 215, and the display mode button 258 communicate via the communication bus 220, which may be a controller area network (CAN) bus. However, it should be understood that other types of wired or wireless communication may be used.

The controller 205 includes an electronic processor 225, an input/output interface 230, and a memory 235. In some embodiments, the controller 205 is a vehicle control unit (“VCU”) that receives information from a plurality of vehicle systems, such as, for example, battery systems, braking systems, engine system, transmission system, or the like, of the motorcycle 100. It should be understood that functionality described herein as being performed by the controller 205 may be distributed among multiple controllers of the motorcycle 100.

In some examples, the electronic processor 225 is implemented as a microprocessor with separate memory, for example the memory 235. In other examples, the electronic processor 225 may be implemented as a microcontroller (with the memory 235 on the same chip). In other examples, the electronic processor 225 may be implemented using multiple processors. In addition, the electronic processor 225 may be implemented partially or entirely as, for example, a field-programmable gate array (“FPGA”), an applications specific integrated circuit (“ASIC”), an x86 processor, and the like and the memory 235 may not be needed or be modified accordingly. In the example illustrated, the memory 235 includes non-transitory, computer-readable memory that stores instructions that are received and executed by the electronic processor 225 to carry out methods described herein. The memory 235 may include, for example, a program storage area and a data storage area. The program storage area and the data storage area may include combinations of different types of memory, for example read-only memory and random-access memory. The input/output interface 230 may include one or more input mechanisms and one or more output mechanisms (for example, general-purpose input/outputs (“GPIOs”), analog inputs, digital inputs, and others).

The memory 235 may store, for example, configuration settings for the HMI control system 200, such as, for example, display mode settings. In some embodiments, configuration settings may be associated with a particular user (e.g., a unique identifier of a rider), which may allow the HMI control system 200 to apply different configuration settings for different users.

The communication interface 210 may be implemented as one or both of a wired network interface and a wireless network interface. The communication interface 210 enables wired and/or wireless communication between the motorcycle 100 and one or more devices or components external or remote from the motorcycle 100. In some instances, the communication interface 210 allows the motorcycle 100 to communicate with the user device 180 over the communication system 190. In some embodiments, rather than or in addition to communicating with the user device 180, the communication interface 210 may communicate with one or more servers or services over the communication system 190. For example, in some embodiments, data from the user device 180 may be communicated to a server, and the communication interface 210 may communicate with the server to retrieve the data. It should also be understood that various intermediary devices (not shown) may exist between the communication interface 210 and the user device 180 (e.g., firewalls, servers, routers, repeaters, etc.).

The one or more sensor(s) 215 may be configured to sense an operational state of the motorcycle 100 or data for determining an operational state of the motorcycle 100. For example, the sensor(s) 215 may detect when the motorcycle 100 is in an idle state or in a drive state or may detect operating conditions of the motorcycle 100 that may be used to determine whether the motorcycle 100 is in an idle state or a drive state. In some embodiments, the sensor(s) 215 may be communicatively coupled to a controller 205 and provide sensor information to the controller 205. The sensor(s) 215 may include, for example, a movement sensor such as a wheel speed sensor or an accelerometer configured to sense movement of the motorcycle 100, a motor encoder for sensing rotation of a shaft in the motor, a drive shaft rotation sensor, a throttle position sensor configured to sense a position of a throttle, a motor voltage sensor configured to sense a voltage across the motor, a motor current sensor configured to sense a current flow through the motor, a wheel rotation sensor configured to sense rotation of the front wheel 115A and/or the rear wheel 115B.

As illustrated in FIG. 2, the handlebars 120 of the motorcycle 100 may include the set of left hand controls 240 and the set of right hand controls 250. In some instances, the handlebars 120 include a left handlebar portion and a right handlebar portion adjoined to the motorcycle 100 at a front fork. The left handlebar portion and the right handlebar portion of the handlebars 120 can define respective longitudinal handlebar portion axes. In those instances, the left hand controls 240 may be positioned on the left handlebar portion and the right hand controls 250 may be positioned on the right handlebar portion. The left hand controls 240 and the right hand controls 250 are positioned to facilitate use by the rider, such as, for example, use with the rider's thumb or other fingers or portions of the rider's hand. In some embodiments, the controller 205 is configured to receive input from at least a subset of the input devices included in the left hand controls 240, the right hand controls 250, or a combination thereof.

The set of left hand controls 240 and the set of right hand controls 250 include various input devices. For example, as one non-limiting example illustrated in FIG. 2, the set of left hand controls 240 includes a horn button 242, a turn signal 244, a communications switch 246, and a lighting switch 248. The horn button 242 is configured to trigger a horn (speaker or other auditory device) of the motorcycle 100 to emit an audible sound. In some embodiments, the horn button 242 is an actuator configured to be pressed by a user. For example, the controller 205 triggers an audible horn of the motorcycle 100 when a user presses the horn button 242.

The turn signal 244 is configured to trigger a turn signal. In some embodiments, the turn signal 244 is an actuator configured to be pressed by a user and/or set in a first position (e.g., left) or a second position (e.g., right). For example, the turn signal 244 causes the controller 205 to activate a left turn signal of the motorcycle 100 when a user places the turn signal 244 in a first position. In another example, the turn signal 244 causes the controller 205 to activate a right turn signal of the motorcycle 100 when a user places the turn signal 244 in a second position. In some instances, the turn signal 244 causes the controller 205 to deactivate a turn signal of the motorcycle 100 when pressed by the user. Alternatively, the turn signal 244 causes the controller 205 to deactivate a right or left turn signal of the motorcycle 100 without an interaction from the user. For example, the turn signal 244 causes the controller 205 to deactivate a right or left turn signal of the motorcycle 100 when a predefined time period expires or in response to a turning motion performed by the motorcycle 100 (e.g., marking the end of a turn designated via a turn signal). In other instances, the turn signal 244 causes the controller 205 to activate hazard lights of the motorcycle 100 when pressed by the user for a defined period of time (e.g., long press).

The communications switch 246 is configured to control communications, such as, for example, accept or decline call or text, activate a voice control, activate a virtual assistant, or the like, which may be received via the user device 180. In some embodiments, the communications switch 246 is an actuator configured to be pressed by a user and/or set in a first position (e.g., up) or a second position (e.g., down). For example, the communications switch 246 causes the controller 205 to accept a call or text message received via the user device 180 when placed in a first position (e.g., up) by a user. In this example, the communications switch 246 causes the controller 205 to decline or end a call or text message received via the user device 180 when placed in a second position (e.g., down) by the user. In some instances, the communications switch 246 causes the controller 205 to initiate a voice feature when pressed by a user. In other instances, the communications switch 246 causes the controller 205 to initiate a voice command prompt for a virtual assistant when pressed by a user for a defined period of time (e.g., long press).

The lighting switch 248 is configured to control one or more lights (e.g., headlights) of the motorcycle 100. In some embodiments, the lighting switch 248 is an actuator configured to be pressed by a user and/or set in a first position (e.g., up) or a second position (e.g., down). For example, the lighting switch 248 causes the controller 205 to activate a high-beam headlight on the motorcycle 100 when placed in a first position (e.g., up) by a user. In this example, the lighting switch 248 causes the controller 205 to activate a low-beam headlight on the motorcycle 100 when placed in a second position (e.g., down) by the user. In some instances, the lighting switch 248 causes the controller 205 to cycle on and off (e.g., flash) a headlight of the motorcycle 100 when pressed by a user.

As also illustrated in FIG. 2, as one non-limiting example, the set of right hand controls 250 includes a start button 252, a cruise control switch 254, a ride mode button 256, and a display mode input device (e.g., button 258). The start button 252 is configured to control an ignition mode of the motorcycle 100. In some embodiments, the start button 252 is an actuator configured to be pressed by a user. For example, the start button 252, when pressed, causes the controller 205 to initiate an ignition mode of the motorcycle 100 when a key fob or other type of key is proximate (e.g., within a predetermined distance) to the motorcycle 100. In another example, the start button 252, when pressed, causes the controller 205 to enable propulsion of the motorcycle 100 when a brake of the motorcycle 100 is activated, a key fob or other type of key is proximate (e.g., within a predetermined distance) to the motorcycle 100, and a throttle of the motorcycle 100 is set to zero (0).

In other embodiments, the start button 252 is an actuator configured to be pressed by a user and/or set in a first position (e.g., up) or a second position (e.g., down). For example, the start button 252 causes the controller 205 to enable an ignition mode of the motorcycle 100 when placed in a first position (e.g., up) by a user. In this example, the start button 252 causes the controller 205 to disable an ignition mode of the motorcycle 100 when placed in a second position (e.g., down) by the user. In some instances, the start button 252, when pressed, causes the controller 205 to enable propulsion of the motorcycle 100 when a key fob or other type of key is proximate (e.g., within a predetermined distance) to the motorcycle 100.

The cruise control switch 254 is configured to control cruise control functions, such as, for example, resume speed, cancel, or set a traveling speed, for the motorcycle 100. In some embodiments, the cruise control switch 254 is an actuator configured to be pressed by a user and/or set in a first position (e.g., down) or a second position (e.g., up). For example, the cruise control switch 254 causes the controller 205 to set a constant travelling speed of the motorcycle 100 when placed in a first position (e.g., down) by a user. In this example, the controller 205 causes the motorcycle 100 to resume traveling at the constant travelling speed when the cruise control switch 254 is placed in a second position (e.g., up) by the user. In some instances, the controller 205 causes the motorcycle 100 to stop travelling at a set constant travelling speed when the cruise control switch 254 is pressed by a user.

The ride mode button 256 is configured to select a set of ride mode operational parameters for the motorcycle 100 (e.g., sport, economy, power, etc.). The display mode button 258 is configured to modify a user interface displayed via the display device 165. In some embodiments, the display mode button 258 is an actuator configured to be pressed by a user. For example, the display mode button 258 causes the controller 205 to modify a user interface displayed via the display device 165 when pressed by a user. In some implementations, the control inputs of the left hand controls 240 and the right hand controls 250 are clearly marked and backlit for visibility in low-light environment, such as, for example, night.

In some implementations, as illustrated in FIG. 2, the set of left hand controls 240 includes only (i.e., is limited to without including other buttons or input devices) the horn button 242, the turn signal 244, the communications switch 246, and the lighting switch 248 and the set of right hand controls 250 includes only (i.e.., is limited to without including other buttons or input devices) the start button 252, the cruise control switch 254, the ride mode button 256, and the display mode button 258. This limited set of controls on each handlebar portion provides a more efficient and easier-to-use control configuration for the rider (e.g., as compared to configurations with additional controls) and avoids unnecessary distractions. For example, the illustrated set of left hand controls 240 and the set of right hand controls 250 limits the number of available inputs and combine different functions into a single input only when such a combination makes sense from a functional perspective. Similarly, in some embodiments, none of the controls are context-sensitive during operation of the vehicle, meaning that the function associated with the control varies based on the current operating context or condition. For example, in some embodiments, each control may have a defined function that may only vary, if at all, between a function assigned when the motorcycle is moving as compared to when the motorcycle is stationary).

In addition, the set of right hand controls 250 focus on throttle (e.g., acceleration and deceleration) and brake while riding plus a few additional functions that are performed infrequently and at times the rider chooses to do so (e.g., distinct from actions like answering a phone call or honking the horn, which may happen at any time). The set of left hand controls 240 focus on other functions (i.e.., other than throttle and brake) that can be performed while the rider's left hand remains on the handlebar/grip (e.g., horn and turn signals). The position of the controls may be configured to provide ideal ergonomic locations, wherein the controls are easy to actuate and provide consistent control for core vehicle operations (e.g., for quick learning and building of muscle memory).

Returning to FIG. 1A, the user device 180 may be mobile computer, such as a laptop computer, a tablet computer, a smart phone, a wearable computing device, or other suitable computing device. Alternately, the user device 180 may be a desktop computer. As illustrated in FIG. 1B, the user device 180 includes an electronic processor 181, a communication interface 183, an interface 185, and a memory 187. The electronic processor 181, the communication interface 183, the interface 185, and the memory 187 communicate over one or more control and/or data buses (for example, a communication bus 189). The electronic processor 181 is a microprocessor or another suitable processing device. The communication interface 183 may be implemented as one or both of a wired network interface and a wireless network interface. The interface 185 may be a device enabling a user to communicate with the user device 180. The memory 187 is one or more of volatile memory (e.g., RAM) and non-volatile memory (e.g., ROM, FLASH, magnetic media, optical media, et cetera). In some examples, the memory 187 is also a non-transitory computer-readable medium. Although shown within the user device 180, the memory 187 may be, at least in part, implemented as network storage that is external to the user device 180 and accessed via the communication interface 183. For example, all or part of the memory 187 may be housed on the “cloud.”

As illustrated in FIG. 1B, the memory 187 stores a configuration application 184 and data 186. The configuration application 184 is a software application containing instructions executable by the electronic processor 181 to configure the motorcycle 100 as described herein. In some embodiments, the configuration application 184 may be a dedicated application for configuring the motorcycle 100. Alternatively, in some embodiments, the configuration application 184 may be a browser application for accessing a web-based service for configuring the motorcycle 100. In some embodiments, the configuration application 184 is configured to generate one or more user interfaces (“UIs”), for example, graphical user interfaces (“GUIs”), for display on a display device (screen, touchscreen, etc.) of the user device 180.

The data 186 stored in the memory 187 may include configuration settings for the HMI control system 200. The configuration settings may be persistently stored in the memory 187 or may be stored in the memory 187 temporarily while a user is using the configuration application 184 and/or viewing and/or modifying configuration settings, wherein, the configuration settings may be transmitted and stored in one or more servers (e.g., a cloud platform) for more persistent storage. In some embodiments, information input via the configuration application 184 are communicated or synchronized with one or more electronic control units of the motorcycle 100, such as the controller 205, which, in some embodiments, includes a telematics control unit (TCU). In other embodiments, configuration settings may be synchronized from the configuration application 184 through a TCU included in the motorcycle 100, and the controller 205 may communicate with the TCU to obtain the configuration settings or may retrieve such settings as stored by the TCU in one or more memory modules of the motorcycle 100.

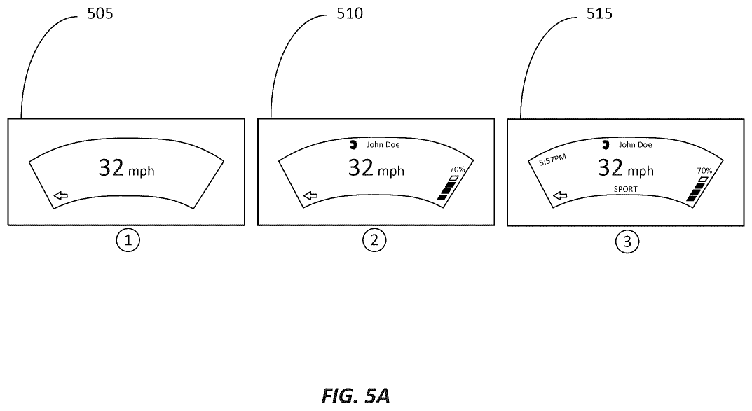

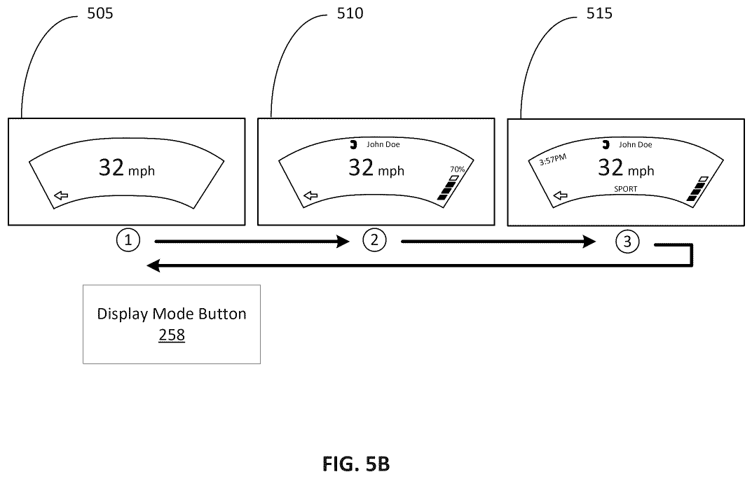

The configuration settings viewable and configurable via the configuration application 184 may include settings for a user-defined display mode of the display device 165. As noted above, the HMI control system 200 may generate user interfaces (for display on the display device 165) according to each of a plurality of display modes and, in some implementations, the plurality of display modes includes a minimal display mode, a custom or user-defined display mode, and an informative display mode. FIG. 5A illustrates an example user interface according to each of these display modes. As illustrated in FIG. 5A, the display modes provide varying levels of information wherein, in some embodiments, each display modes builds on a different display mode (e.g., adding additional information). As each display mode is a digital user interface, displayed information can be presented clearly and legible. For example, as compared to user interfaces that may merely attempt to digitalize an existing analog display, the displays modes may dynamically change the size and location of displayed information to optimize clarity of information in each display mode. In particular, rather than just turning off the display of particular information in a particular defined area of the display (e.g., leaving that portion of the display blank or reserved), the displayed information associated with a selected display mode may be configured to use as much of the available space as possible. In some embodiments, certain information may be retained in the same general location between displayed modes (e.g., to prevent a user from having to search for needed or desired information within the user interface).

As illustrated in FIG. 5A, user interface 505 represents a minimal display mode (e.g., including context sensitive and critical information, such as, for example, legally required information and critical information), user interface 510 represents a user-defined display mode (e.g., including the information included in the minimal display mode plus user preferences), and user interface 515 represents an informative mode (e.g., including the information included in the minimal display mode plus more to provide, for example, all available information). As illustrated in FIG. 5A, in some embodiments, the user-defined display mode and the informative display mode may include user or rider information, such as an identifier of the profile (stored configuration settings) being used to display information. The minimal display mode illustrated in user interface 505 includes the least amount of information with respect to the user-defined display mode and the informative display mode. For example, in the minimal display mode, the user interface 505 may only include information of the motorcycle 100 required by law (e.g., speed information) and/or context sensitive critical information (e.g., telltale information, such as, for example, turn signals, tire pressure warnings, etc.). The minimal display mode reduces distractions caused by information (e.g., call alerts, navigational information, etc.) presented on the display device 165 when a rider is operating the motorcycle 100.

In contrast to the minimal display mode, the user interface 510 in the user-defined display mode includes the information included in the minimal display mode and user-defined additional information, as set as part of the configuration settings for the HMI system 200. The user defined display mode enables a rider to personalize information presented on the display device 165. Similarly, the user interface 515 representing the informative display mode includes the information provided in the minimal display mode plus additional information to provide the rider a content-rich experience. In particular, as compared to the user-defined display mode, the informative display mode (or some types of information displayed in this mode), the minimal display mode (or some types of information displayed in this mode) may be static or fixed (i.e., cannot be customized).

Accordingly, as noted above, in some embodiments, the minimal display mode, the user-defined display mode, and the informative display mode represent varying levels of information (e.g., moving from a least amount of information to a greatest amount of information), wherein each mode may build upon (i.e., add to) information provided via the previous mode. The display modes allow a user to easily choose a level of information to view while operating the vehicle (i.e., through operation of the display mode button 258) to match a user's preferences or current operating environment or need as well as allow a user to customize at least one of the display modes (when the user is not operating the vehicle). For example, as illustrated in FIG. 5B, in response to each operation of the display mode button 258, the HMI control system 200 (e.g., the controller 205) is configured to switch the display mode of the user interface displayed via the display device 165 to the next mode in a predetermined sequence of the display modes. In other words, a user can use the display mode button 258 (i.e., a single control) to cycle through the available display modes in an efficient and minimally distracting way. For example, as compared to navigating through various menus, layers, pages, tabs, or other complicated portions for accessing information and making customizations and selections (e.g., navigating to and conforming a selection), a user can use the display mode button 258 to easily modify how information is provided (e.g., what level or amount of information is provided).

The configuration application 184 is configured to receive user input for setting configuration settings of the user-defined display mode. For example, as described herein, the configuration application 184 is configured to provide one or more graphical user interfaces (GUIs) for receiving configuration settings for a user-defined display mode of a vehicle. A GUI provided via the application 184 may include one or more GUI elements, wherein each respective GUI element sets one of a first plurality of information types to one of a plurality of display settings. As also described above, the configuration application 184 is also configured to communicate the configuration settings to a controller included in the motorcycle 100 (e.g., the controller 205), wherein the controller stores the configuration settings for use when the user-defined display mode is selected (e.g., via the display mode button 258). Setting the configuration settings through the configuration application 184 executed on a remote device allows the display device, input devices, or both on the motorcycle 100 to be simplified and encourages a rider to configure such settings while the motorcycle 100 is off or idle (not operating or moving).

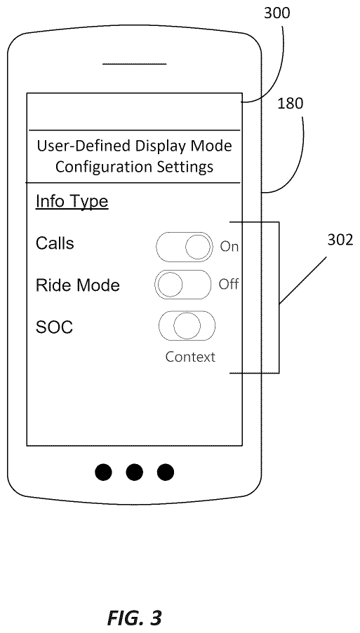

FIG. 3 illustrates an example graphical user interface (GUI) 300 provided via the configuration application 184 as executed on the user device 180. The GUI 300 includes one or more GUI elements 302 for receiving user input (e.g., drop-down menus, radio buttons, checkboxes, etc.). The user input may specify, for the user-defined display mode, whether a particular type of information is always displayed (“On” selection), never displayed (“Off” selection), or displayed in predetermined contexts or conditions (“Context” selection). The GUI elements 302 may function as both a user input as well as an output or indication indicating a current configuration. For example, in the example GUI 300, three different types of information are listed (calls, ride mode selection, and state-of-charge (SOC)) and an GUI clement 302 is provided for each respective type of information that indicates the current configuration setting for the information as well as an option for setting the configuration setting. In the example of FIG. 3 and the illustrated configuration settings, information regarding calls is always displayed in the user-defined display mode, information about what ride mode is currently selected is never displayed in the user-defined display mode, and information regarding a SOC of a battery of the vehicle is only displayed in particular contexts. In some embodiments, a configuration setting may be associated with additional information and associated options. For example, an information type set to the context setting may include additional GUI elements for setting additional options. Using the SOC information as a non-limiting example, if this type of information is set to the context setting, a user may be able to (through the GUI 300) input a battery level threshold for when SOC information should be displayed. As another example, if call information is set to the context setting, a user may be able to (through the GUI 300) select whether call information is limited to particular contacts, during particular driving conditions, during particular times, etc. As yet another example, if ride mode information is set to the context setting, a user may be able to (through the GUI 300) select whether information regarding only particular ride modes should be displayed. It should be understood that various thresholds, conditions, rules, and other logic may be associated with particular configuration settings, which may be configurable through the configuration application 184. Also, for some types of information, the configuration settings may not include an “Off” setting. For example, for SOC information, the configuration settings may be limited to an “On” setting (meaning the current SOC is always displayed) and a “Context” setting (meaning, for example, that SOC information is only displayed in response to particular conditions, such as, for example, a SOC falling below a predefined or user-customized threshold). Also, in some embodiments, rather than simply eliminating the “Off” setting, the “Off” setting may represent a minimum setting. For example, using the SOC information again, the “Off” setting may include a critical threshold where SOC information is only displayed when it drops below a minimum threshold (e.g., a 5% or 10% SOC). Also, in some embodiments, different configuration settings may be available for different operating modes of the motorcycle 100. For example, in some embodiments, different configuration settings may be used to control what is displayed in a particular display mode when the motorcycle 100 is moving/operated as compared to when the motorcycle 100 is stationary, being charged, or the like.

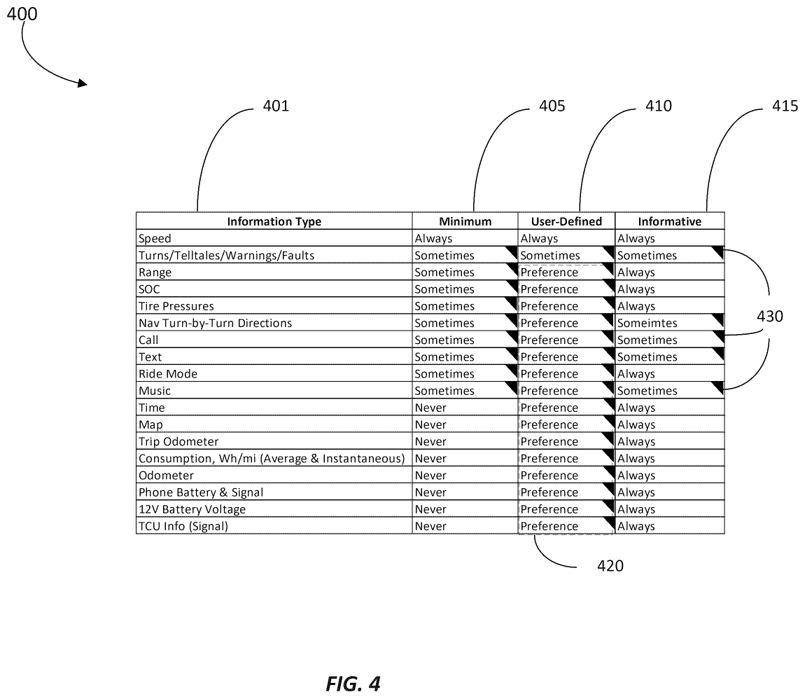

FIG. 4 illustrates additional examples of configuration settings 400 for various types of information (see information type field 401). The configuration settings 400 include settings 405 for the minimal display mode (which may be static), settings 410 for the user-defined display mode (which may be modified), and settings 415 for the informative display mode (which may be static). As illustrated in FIG. 4, the different types of information may represent information related to travel range, state of charge (“SOC”), tire pressure, navigation directions, call notifications, text notifications, ride mode, music, map, trip odometer, odometer, user device status, battery voltage, and telematics control unit (“TCU”) information. However, it should be understood that the configuration settings 400 described herein represent one possible set of such settings and other settings may be used with the motorcycle 100 and other types of vehicles. As also illustrated in FIG. 4, the configuration settings for the user-defined display mode may include the “On” (“Always”) and “Context” (“Sometimes”) configuration settings of the minimal display mode and a user can configure the other available types of information (see the information types 420 indicated as “Preference”). As compared to the user-defined display mode, the informative display mode may include the “On” (“Always”) and “Context” (“Sometimes”) configuration settings of the minimal display mode and default, static configuration settings for those information types configurable in the user-defined display mode.

As represented by the corner indicator 430 included in the configuration settings 400, an information type with a setting of “Context” (“Always” or “Sometimes”) in a display mode (or configurable to such a setting, such as the information types 420) may be associated with one or more options, which, in some embodiments, may be configurable. For example, as noted above, if information about calls is set to the “Context” setting, a user may be able to configure the situations or conditions when such information is to be included within the user-defined display. In some embodiments, information types in other display modes statically set to the “Context” setting may similarly have configurable options. In other words, while a user may not be able to change the setting for a particular type of information in the minimal or informative display modes, a user may be able (through the configuration application 184) to configure the situations when such information is displayed in one or both of these modes. As also noted above, the types and number of options for a “Context” configuration setting can vary and relate to the associated type of information.

In some embodiments, a user configures options of the information types 420 marked with the indicator 430. For example, as one non-limiting example illustrated in FIG. 4, the information types 420 include travel range, tire pressure, navigation directions, call notifications, text notifications, ride mode, media (music), map, consumption, and cruise control. The travel range information type includes configurable options, such as, for example, always show travel range (e.g., in miles or kilometers), show travel range when the travel range is below a preset number (e.g., in miles or kilometers), or show travel range when the travel range is below a user defined number. The tire pressure information type includes configurable options, such as, for example, always show tire pressures (e.g., in psi/kPa), show tire pressure when a pressure of one or more tires is below a preset pressure, or show tire pressure when a pressure of one or more tires is below a user defined pressure. The navigation directions information type includes configurable options, such as, for example, always show a next direction (e.g., a turn) when navigating, or show a next direction (e.g., a turn) a user defined distance before a location corresponding to the next direction, for example, the turn, or a user defined time before the direction (e.g., a turn) is completed (e.g., a user completes a turn). The call and/or text notification information type includes configurable options, such as, for example, show communication (e.g., a call or a text) information when received, show communication information when received from a user defined group of contacts, or never show communication information. The ride mode information type includes configurable options, such as, for example, always show ride mode, show ride mode while the ride mode is being changed, or show ride mode while the ride mode is being changed and/or show ride mode for a preset or user defined time period after the ride mode is changed. The media (e.g., music) information type includes configurable options, such as, for example, always show music information when playing, show music information when music source is being changed (e.g., radio station, input source), show music information when song changes, show music information when music source or song is being changed and/or show music information for a preset or user defined time period after a change occurs, or never show music information. The map information type includes configurable options, such as, for example, always show map when navigating, show map when in use, or show map a preset or a user defined distance or time before a direction is completed (e.g., a user completes turn). The consumption information type includes configurable options, such as, for example, always show consumption (e.g., in Wh/mi), which may be an average consumption, an instant consumption, or a combination thereof, or never show consumption. The cruise control information type includes configurable options, such as, for example, always show a cruise control icon (e.g., activate icon when cruise control is set, deactivate icon when cruise control is not set), always show cruise control icon when cruise control is enabled, or show cruise control cruise control icon for a preset or user defined time period after the cruise control is set or changed.

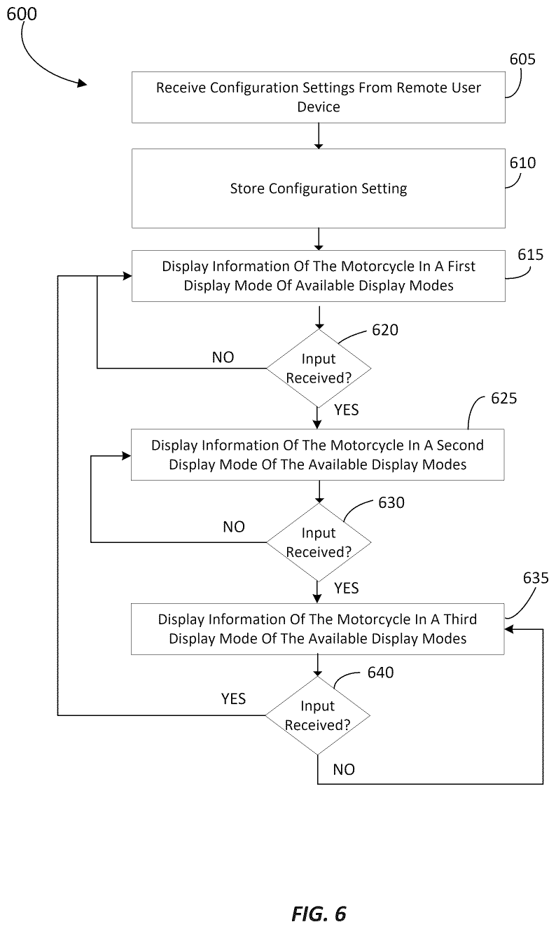

FIG. 6 is a flowchart illustrating an example method 600 for operating a display of a vehicle. The method 600 is described as being performed by the controller 205 of the system 200 and, in particular, the electronic processor 225 executing instructions stored in the memory 235. However, it should be understood that the method 600 may be performed in a distributed manner and may include additional or fewer steps in various sequences in other embodiments.

As illustrated in FIG. 6, the method 600 includes the controller 205 receiving, from the application 184 of the user device 180, configuration settings for at least one display mode of a plurality of available display modes (at block 605). For example, the controller 205 receives, via the communication interface 210 from the user device 180, configuration settings for the user-defined display mode as set by the user via the configuration application 184 and the GUI elements 302 as described herein. The controller 205 may update configuration settings (e.g., as stored in the memory 325) based on the received information (at block 610). As described above, the configuration settings may be communicated to the motorcycle 100 when the motorcycle 100 is not operating or in an idle state, such that configuration settings cannot be modified during operation of the motorcycle. Also, using the user device 180 to set the configuration settings avoids the need for a user to attempt to make such selections through HMIs of the vehicle, which may be limited in terms of screen size, inputs, etc. and may otherwise act as a distraction to the user when operating the vehicle.

The method 600 also includes displaying, on the display device 165, information regarding the motorcycle 100 in a first display mode of a plurality of available display modes (at block 615). For example, the controller 205 may be configured to generate a user interface, including information regarding the motorcycle 100, for display on the display device 165 according to configuration settings of a first display mode of the plurality of available display modes and transmit the user interface to the display device 165 for display. In some implementations, the first display mode may be a default display mode (e.g., the minimal display mode or other display mode that may be selected by a user as the default or starting mode) or may be a previously-defined display mode, such as, for example, the last display mode that was selected by the user during previous operation of the motorcycle 100. For example, the controller 205 may store an indicator of a currently used display mode and, when the motorcycle 100 is turned off, this indicator may be persistent and used when the motorcycle 100 is subsequently started to identify what display mode should be used upon start-up of the motorcycle 100 (e.g., to continue the rider's desired level of information as set during a previous ride). It should be understood that the information included in the user interfaces generated by the controller 205 may be determined by the controller 205 based on information received over the bus, such as information from the one or more sensors or other vehicle systems.

As illustrated in FIG. 6, while the information in the first display mode is being displayed, the controller 205 determines whether an input is received via the display mode button 258 (at block 620). In response to no input being received, the controller 205 continues to display the user interface in the first display mode and determine whether input is received (block 620, “NO” branch). Alternatively, in response to receiving input via the display mode button 258 (block 620, “YES” branch), the controller 205 switches to displaying information regarding the motorcycle 100 in a second display mode of the plurality of available display modes (at block 625). For example, as noted above, activation of the display mode button 258 may cycle through available display modes in a predetermined sequence and, for each display mode in the sequence, the controller 205 may access stored information to determine the configuration settings for the display mode and generate a user interface accordingly. As noted above, in some embodiments, the user-defined display mode may be the “next” display mode after the minimal display mode.

It should be understood that the controller 205 may be configured to modify or otherwise switch how information is displayed via the display device 165 to a different display mode by generating a new user interface according to the appropriate configuration settings and communicating the user interface to the display device 165 for output. In other embodiments, however, the controller 205 may be configured to modify or switch how information is displayed by modifying the information transmitted to the display device 165. For example, in some embodiments, the display device 165 may output a user interface according to a template populated based on information provided via the controller 205 and, optionally, other controllers or sources. In this configuration, the controller 205 may modify the displayed user interface by modifying what information is transmitted or otherwise communicated to the display device 165. Similarly, the controller 205 may be configured modify a displayed user interface by enabling or disabling various data feeds to the display device 165. Accordingly, various methods may be used to modify or switch a currently-displayed user interface from one display mode to a different display mode and embodiments described herein are not limited to any particular method.

While the user interface representing the second display mode is being displayed, the controller 205 determines whether an input is received via the display mode button 258 (at block 630). In response to no input being received, the controller 205 continues to display the user interface in the first display mode and determine whether input is received (block 630, “NO” branch). Alternatively, in response to receiving input via the display mode button 258 (block 630, “YES” branch), the controller 205 switches to displaying information about the motorcycle 100 according to configuration settings of a third display mode of the plurality of available display modes (at block 635). Again, when cycling through available display mode, the informative display mode may be the “next” display mode after the user-defined display mode. However, as previously noted, while three different display modes have been described, different numbers of display modes may be implemented, and various sequences of such display modes may be defined and optionally configured by the user.

As illustrated in FIG. 6, while the user interface is displayed in the third display mode, the controller 205 determines whether a user selection is received from the display mode button 258 (at block 640). In response to no input being received, the controller 205 continues to display the user interface in the third display mode and determine whether input is received (block 640, “NO” branch). Alternatively, in response to receiving input via the display mode button 258 (block 640, “YES” branch), the controller 205 switches to displaying information about the motorcycle 100 according to configuration settings of the first display mode of the plurality of available display modes (at block 615). As noted above, in some embodiments, the plurality of available display modes may include more than three modes and, in such embodiments, the controller 205 may be configured to cycle through all available display modes before returning to a first or starting display modes. It should also be understood that, in some embodiments, the controller 205 may cycle through available display modes in various sequences, such as, for example, by moving from a mode with the least information to a mode with the most information and then reversing the order (moving back from most information to least information). Similarly, in some embodiments, the controller 205 is configured to start with a custom display more or a display mode having the most information, and, in some embodiments, a user may specify which mode to start with and how to cycle or switch between the display modes (e.g., through the configuration application 184).

Accordingly, as illustrated in FIG. 6 and described above, the controller 205 is configured to set, from a plurality of available display modes, a display mode for information displayed via the display device 165, wherein the plurality of available display modes includes a first display mode including a first set of information (e.g., a minimal display mode), a second display mode including the first set of information and a second set of information and being configurable (e.g., a user-defined display mode), and a third display mode including the first set of information and a third set of information (e.g., the informative display mode). The initially set display mode may include a default mode of the available modes or a starting mode as defined by a user (e.g., during previous operation or as part of a stored user setting or profile). The controller 205 is also configured to switch, during operation of the vehicle, the display mode for information displayed via the display device 165 among the plurality of available display modes in response to each input received via the display mode button 258. As described above, the controller 205 may move through the available modes in various sequences and, in some embodiments, the sequence may be configurable by the user.

Thus, embodiments described herein provide systems and methods for controlling a vehicle (e.g., motorcycle) HMI, including, for example, providing display modes presenting various levels or amounts of information via the HMI, wherein a user can easily scroll through available display modes and configure settings for at least one of the available display modes.

It should be understood that the various input mechanisms described herein may be take various forms and the examples provided herein are not limiting. For example, an input mechanism described as being an actuator, a button, a switch, or the like, may be implemented in different ways using different mechanical and/or electronic input mechanisms. Accordingly, the terms “input mechanism” and “input device” as used herein should not be limited to any particular type of mechanism. For example, the display mode device 258 may include a button, a switch, or other input that allows a user to cycle through (e.g., in one or more directions) available display devices, wherein, for example, each input received through the device 258 switches the currently-used display mode to a different display of the plurality of available display modes (e.g., without requiring any additional inputs, confirmations, etc.).

It should be understood that the processes described herein may be used independently or in combination. Also, although the system and associated methods have been described in detail with reference to certain preferred embodiments, variations and modifications exist within the scope and spirit of one or more independent aspects of the described processes and associated systems and devices as described. One or more independent features and/or independent advantages may be set forth in the claims.

What is claimed is:

1. A vehicle comprising:
a display device;
an input device; and
an electronic controller including an electronic processor and memory, the electronic controller configured, during operation of the vehicle, to:
display, on the display device, information regarding the vehicle in a first display mode of a plurality of available display modes, the first display mode including a first set of information, and
in response to receiving input via the input device while the information is displayed in the first display mode, switch to displaying information regarding the vehicle in a second display mode of the plurality of available display modes, the second display mode including the first set of information and a second set of information, the second set of information being configurable.

2. The vehicle of claim 1, wherein the electronic controller is further configured to, in response to receiving input via the input device while the information is displayed in the second display mode, switch to displaying information regarding the vehicle in a third display mode of the plurality of available display modes.

3. The vehicle of claim 2, wherein the third display mode includes the first set of information and a third set of information.

4. The vehicle of claim 3, wherein the third set of information is fixed.

5. The vehicle of claim 1, further comprising a communication interface, wherein, the electronic controller is further configured to:
receive, from a user device via the communication interface, configuration settings for the second set of information.

6. The vehicle of claim 5, wherein the configuration settings include, for each of a plurality of information types, one selected from a group consisting of an “On” setting, an “Off” setting, and a “Context” setting.

7. The vehicle of claim 5, wherein the electronic processor is configured to display the information in the second display mode based on the configuration settings.

8. The vehicle of claim 1, wherein the first set of information is fixed.

9. The vehicle of claim 1, wherein the electronic processor is configured to cycle through the plurality of available display modes in response to each input received via the input device.

10. The vehicle of claim 1, wherein the input device is a dedicated input device positioned on a handlebar of the vehicle.

11. The vehicle of claim 1, wherein the input device is positioned on a right portion of a handlebar of the vehicle.

12. A system for controlling a human machine interface of a vehicle, the system comprising:
an input device; and
an electronic controller including an electronic processor and memory, the electronic controller configured, during operation of the vehicle, to:
set, from a plurality of available display modes, a display mode for information displayed via a display device, the plurality of available display modes including a first display mode including a first set of information, and a second display mode including the first set of information and a second set of information and being configurable, and
switch, during operation of the vehicle, the display mode for information displayed via the display device among the plurality of available display modes in response to each input received via the input device.

13. The system of claim 12, further comprising:
a first set of controls positioned on a first portion of a handlebar of the vehicle, the first set of controls limited to a horn input device, a turn signal input device, a communications input device, and a lighting input device; and
a second set of controls positioned on a second portion of the handlebar, the second set of controls limited to a start input device, a cruise control input device, a ride mode input device, and the input device,
wherein the electronic controller is configured to receive input from at least a subset of the first set of controls and the second set of controls.

14. The system of claim 13, wherein the first set of controls is positioned on a left portion of the handlebar and the second set of controls is positioned on a right portion of the handlebar.

15. The system of claim 13, wherein the plurality of available display modes provides a varying amount of information regarding the vehicle.

16. The system of claim 15, wherein a first display mode of the plurality of available display modes includes a first set of information and a second display mode of the plurality of available display modes includes the first set of information and a second set of information.

17. The system of claim 16, wherein the first set of information is fixed.

18. The system of claim 17, wherein the second set of information is configurable.

19. A non-transitory computer-readable medium storing instructions that, when executed by an electronic processor, perform a set of functions, the set of functions comprising:
providing a graphical user interface (GUI) for receiving configuration settings for a user-defined display mode of a vehicle, the GUI including a plurality of GUI elements, each respective GUI element setting one of a first plurality of information types to one of a plurality of display settings; and
communicating the configuration settings to a controller included in the vehicle, the controller storing the configuration settings for use in response to selection of a user-defined display mode of the vehicle from a plurality of available display modes via at least one input device mounted on the vehicle, the plurality of available display modes including at least one fixed display mode including default display settings for a second plurality of information types.

20. The non-transitory computer-readable medium of claim 19, wherein the plurality of available display modes provides varying amounts of information regarding the vehicle on a display device of the vehicle.
